(19) United States
(12) Patent Application Publication
(10) Pub. No.: US 2011/0153104 A1
(43) Pub. Date: Jun. 23, 2011

(54) APPLIANCE WITH ENERGY CONSUMPTION REPORTING AND METHOD

(75) Inventors: Jeff Donald Drake, Louisville, KY (US); Timothy Dale Worthington, Crestwood, KY (US); Michael Francis Finch, Louisville, KY (US); Joseph Mark Brian, Louisville, KY (US); Henry Nader Kobraci, Louisville, KY (US); Darin L. Franks, Lanesville (IN); Chad Michael Helms, Louisville, KY (US); Nagaraju Valluri, Louisville, KY (US)

(73) Assignee: General Electric Company

(21) Appl. No.: 12/900,560

(22) Filed: Oct. 8, 2010

Related U.S. Application Data
(63) Continuation-in-part of application No. 12/644,552, filed on Dec. 22, 2009.

(51) Int. Cl. G06F 1/26

(52) U.S. Cl. 700/291

(57) ABSTRACT

A system is provided for determining and displaying the cost of consuming power comprising an appliance including one or more power consuming functions wherein each of the one or more power consuming functions includes an associated power consumption amount. The system compensates for line voltage variations by sensing line voltage and adjusting the power consumption amount. The system further provides a home energy management system (HEM) including a controller in communication with the appliance and configured to provide the HEM with the associated power consumption amount of each of the one or more power consuming functions. The controller being configured to convert the current cost of supplied energy into a power consumption cost of the associated power consumption amount of the one or more power consuming functions.

This is a continuation-in-part of U.S. patent application Ser. No. 12/644,552, filed on Dec. 22, 2009, which is hereby incorporated herein by reference in its entirety.

### BACKGROUND

This disclosure relates to energy management, and more particularly to electrical device control methods and electrical energy consumption systems. The disclosure finds particular application to energy management of home appliances, for example, dishwashers, clothes washers, dryers, HVAC systems, etc.

Many utilities are currently experiencing a shortage of electric generating capacity clue to increasing consumer demand for electricity. Currently utilities generally charge a flat rate, but with increasing cost of fuel prices and high energy usage at certain parts of the day, utilities have to buy more energy to supply customers during peak demand. Consequently, utilities are charging higher rates during peak demand. If peak demand can be lowered, then a potential huge cost savings can be achieved and the peak load that the utility has to accommodate is lessened. In order to reduce high peak power demand, many utilities have instituted time of use metering and rates which include higher rates for energy usage during on-peak times and lower rates for energy usage during off-peak times. As a result, consumers are provided with an incentive to use electricity at off-peak times rather than on-peak times. And to reduce overall energy consumption of appliances at all times.

Presently, to take advantage of the lower cost of electricity during off-peak times, a user must manually operate power consuming devices during the off-peak times. This is undesirable because a consumer may not always be present in the home to operate the devices during off-peak hours. This is also undesirable because the consumer is required to manually track the current time to determine what hours are off-peak and on-peak.

One proposed third party solution is to provide a system where a controller “switches” the actual energy supply to the power consuming device on and off. However, there is no active control beyond the mere on/off switching. There are also currently different methods used to determine when variable electricity-pricing schemes go into effect. There are phone lines, schedules, and wireless signals sent by the electrical utility company. One difficulty is that different electrical companies use different methods of communicating periods of high electrical demand to their consumers. Other electrical utility companies simply have rate schedules for different times of day. Therefore, there is a need to provide a system that can automatically operate power consuming devices during off-peak hours in order to reduce consumer's electric bills and also to reduce the load on generating plants during on-peak hours. Active and real time communication of energy costs of appliances to the consumer will enable informed choices of operating the power consuming functions of the appliance.

Electrical utilities moving to an Advanced Metering Infrastructure (AMI) system will need to communicate to appliances, HVAC (i.e. room or whole house), water heaters, etc. in a home or office building. All electrical utility companies (more than 3,000 in the US) will not be using the same communication method to signal, in the AMI system. Similarly, known systems do not communicate directly with the appliance using a variety of communication methods and protocols, nor is a modular and standard method created for communication devices to interface and to communicate operational modes to the main controller of the appliance. Although conventional WiFi/ZigBee/PLC communication solutions are becoming commonplace, this disclosure introduces numerous additional lower cost, reliable solutions to indicate and communicate cost of energy in appliances or other users of power. This system may also utilize the commonplace solutions as parts of the communication protocols.

Providing consumers access to real time information about the energy they consume helps them reduce their consumption. Many systems are being experimented with today for utilities to provide the meter data from a person's home to the consumer. This gives the consumer some additional basic data. For example, when the air conditioner is running, the rate of consuming electricity is high. Such systems, however, do not provide the consumer with a more in-depth understanding electricity usage (e.g., does the dryer, which draws a lot of power for a short period of time, have a bigger impact on my energy consumption than the refrigerator that draws lower power for a longer period of time).

U.S. Pat. No. 5,572,438 to Ehlers et al. discloses measuring the energy consumption at each appliance. This provides very accurate measurements, but at the cost of expensive hardware. While this may be cost-effective in an industrial application, consumers don't need revenue grade metering at each appliance

U.S. Pat. No. 4,575,801 to Hoberman et al. measures the on time at each device and reports the same to a central server. The central server then calculates a bill based this usage data and rate information stored in its memory. This approach requires a central server, which adds cost, and requires frequent communication of the state of the appliance to avoid inaccuracies. In order to avoid inaccuracies, Hoberman monitors the state of the devices every 1/60^{th} of a second. U.S. Pat. No. 7,181,293 to Rothman extends this by polling each device for a state. This approach accommodates a more complicated device that has astute other than off and on. However, this still requires frequent communication to minimize error. In a wireless network, this frequent communication provides network congestion requiring a faster network, and faster communication consumes more electrical power.

In prior approaches where the on time of the device or function is used to calculate energy use, error can be introduced when the line voltage supplied to the device fluctuates. More particularly, a decrease in line voltage of the power supplied to a device or appliance reduces the actual amount of power consumed by the device over a given period of time. This results in a variance between a nominal power rating (or value) for the device/function and the actual power consumption by the device. The variance due to changes in line voltage can produce significant error, especially for appliances and other devices that draw larger quantities of power, or when such variances accumulate over time.

### SUMMARY OF THE DISCLOSURE

The present disclosure provides a system and method for calculating actual energy consumed by an appliance without the need for additional hardware to be installed at the appliance.

Line voltage variation is compensated for by measuring the line voltage and calculating actual power. Many devices already include hardware for measuring line voltage to detect brown out events and cease operation. If the appliance nominal power consumption value is stored in memory at 120V, actual power can be calculated by the equation:

actualpower=120Vpower*(actualvoltage/120).

Accordingly, an appliance with an energy consumption reporting function comprises one or more power consuming functions, each of the one or more power consuming functions having one or more operating states associated with respective power consumption value, a controller operable to activate the one or more power consuming functions, the controller configured to determine an energy consumption amount for the appliance by accumulating the power consumption amounts for each power consuming function based on the amount of time each operating state is detected, and a communication interface for communicating the energy consumption amount.

The appliance can further comprise a memory accessible by the controller for storing one or more power consumption values. The one or more power consumption values can comprise a monetary value per unit of time. The power consumption value can be multiplied by a respective cycle time to calculate the energy cost of each of the one or more power consuming functions. The energy cost of each of the one or more power consuming functions can be summed by the controller to provide a total energy cost consumption of the appliance. The communication device can include a display associated with the appliance for displaying the amount of energy consumed. The appliance can further comprise an input for receiving energy cost data to be used by the controller for displaying the amount of energy consumed as a monetary amount. The controller can be operable to sense a line voltage of power supplied to the appliance, and further configured to adjust the power consumption values based on the sensed line voltage to thereby account for variances in line voltage. The appliance can be configured to report the local line voltage via the communication interface. The communication interface can be further configured to receive a line voltage from a remote source, and communicate the line voltage to the controller, wherein the controller can be configured to adjust the power consumption values based on the sensed line voltage to thereby account variances in line voltage.

In accordance with another aspect, a method of determining the energy consumption of an appliance comprises associating one or more operating states of one or more power consuming functions of an appliance with a respective power consumption value, detecting activation of the one or more operating states, and calculating energy usage of the appliance by accumulating the power consumption value for each power consuming function based on the amount of time each operating state is detected.

The one or more power consumption values can comprise a monetary value per unit of time, whereby the power consumption value is multiplied by a respective cycle time to calculate an energy cost of each of the one or more power consuming functions. The energy cost of each of the one or more power consuming functions can be summed by a processor to provide a total energy cost of the appliance. The method can further comprise displaying an amount of energy consumed on a display associated with the appliance. The method can include sensing a line voltage of power supplied to the appliance, and adjusting the power consumption values based on the sensed line voltage to thereby account for variances in line voltage and/or reporting the local line voltage via a communication interface to a home energy manager. The method can include receiving a line voltage from a remote source, and adjusting the power consumption values based on the sensed line voltage to thereby account for variances in line voltage.

Still other features and benefits of the present disclosure will become apparent from reading and understanding the following detailed description.

### BRIEF DESCRIPTION OF THE DRAWINGS

FIG. 1 is a schematic illustration of an exemplary home energy management system in accordance with the present disclosure.

FIG. 2 is a flowchart illustrating a method in accordance with the present disclosure.

### DETAILED DESCRIPTION OF THE PREFERRED EMBODIMENTS

The central controller handles energy management between the utility and home appliances, lighting, thermostat/HVAC, etc. with customer choices incorporated in the decision making process. The controller may include determining and displaying energy consumption based on particular power consuming functions/features. It is to be appreciated that each power consuming function includes an associated power consumption amount.

To be described hereinafter, a system for determining and displaying the cost of consuming power is provided and comprises an appliance including one or more power consuming functions wherein each of the one or more power consuming functions includes an associated power consumption amount. A home energy management system (HEM) can be connected with the appliance and can include a controller in communication with the appliance and configured to provide the HEM with the associated power consumption amount of each of the one or more power consuming functions. The controller is in signal communication with an associated utility wherein the controller receives and processes a signal from the associated utility indicative of current costs of supplied energy. It is to be appreciated that the present disclosure provides the ability to enable the consumer or user an opportunity to monitor, look up, calculate, track, compare, and/or record the power consumption cost of each of the one or more power consuming functions. The consumer also has the ability to monitor, calculate, compare, and contrast the power consumption cost of the appliance functions and features at various energy levels. For example, the power consumption cost can be compared and contrasted from one function to another function as the user makes functional selections on the appliance. In addition, the display can also analyze cost comparisons or display the cost comparisons based on a usage or preselected timeframe.

Depending on which particular appliance is being monitored, the one or more power consuming functions can comprise the following: power on, idle, wash cycle, rinse cycle, fill cycle, pump out cycle, spin cycle, cool, defrost, bake, broil, self-clean cycle, microwave, exhaust fan, and dry cycle. The power consumption cost of each of the one or more power consuming functions can be multiplied by a respective cycle time to calculate the energy cost of each of the one or more associated power consuming functions. The power consumption cost of each of the one or more power consuming functions can be summed and reported as a total for the respective appliance.

Alternatively, in another embodiment, the power consumption cost can be estimated by the appliance. The associated power consumption amount of each of the one more power consuming functions is determined by using a table of power load values pre-loaded into a memory of the appliance and the amount of time the respective load was in the “ON” state. As one illustrative example, Table 1 displays possible functional options for a clothes washer. The operator can first select normal (N), light (L), or heavy (H) feature for each of the wash (W) and rinse (R) cycles. The operator can then select the water temperature of hot (H), warm (W), or cold (C). The combination of the selected wash, rinse, and associated spin cycles will each comprise a certain amount of power consumption, i.e. pre-loaded table of power consumption values associated with each power consuming function. At the same time, a water level can be selected to accompany the wash and rinse cycles (low (L), medium (M), and high (H)). The selected wash, rinse, water temperature, and water level will result in a total power consumption amount. This power consumption can be displayed and compared against, for example, a standard or normal (i.e. average) power consumption in order for the consumer to compare and contrast the selected features. The difference in power consumption between the selected features and the ‘average’ features can be annualized (based on historical consumer usage data) in order for the consumer to make informed decisions of whether to run the appliance with the selected features or modify the selected features. Once the appliance runs with the selected features, the HEM can monitor, look-up, calculate, track, compare, and/or record the power consumption cost of each of the selected power consuming features and compile the power consumption of a complete appliance functional cycle (i.e. load of wash).

### Appliance

### Function/Feature

TABLE 1

| | | | | | | | | | | WATER |
|---|---|---|---|---|---|---|---|---|---|---|
| TEMP | NW | NR | NS | LW | LR | LS | HW | HR | US | LEVEL |
| HOT | NWH | NRH | NS | LWH | LRH | LS | HWH | HRH | HS | L |
| WARM | NWW | NRW | NS | LWW | LRW | LS | HWW | HRW | HS | M |
| COLD | NWC | NRC | NS | LWC | LRC | LS | HWC | HRC | HS | H |

Alternatively for the washer, the power can be tracked by each of the power consuming devices in the washer. See Table 2. This is a simplified model. As the cycle proceeds, the necessary components are energized, and the control keeps track of which component has been energized for how long.

TABLE 2

| | Component | | | | |
|---|---|---|---|---|---|
| | Hot Water | Cold Water | Motor | | Motor |
| | Valve | Valve | (Agitate) | Drain Pump | (Spin) |
| Wattage | 5 W | 5 W | 400 W | 25 W | 200 W |

During a warm fill, the control knows it has the hot and cold water valves on. Every second it increments the energy consumption by 10. After a 3 minute fill the counter will be at 10*60*3=1800 Watt-sec.

Then during a 15 min agitate, each second the counter will increment by 400, and at the end of agitate the counter will read 1800+400*60*15=361800 Watt-seconds. As the cycle continues the counter will continue to record the power consumption.

At any time in the cycle the appliance control can communicate this measurement to through the communication port. It can be periodically, say every five minutes, or at the end of a cycle, or when requested.

The present disclosure provides a method of determining the cost of consuming power comprising associating one or more power consuming functions of an appliance with a corresponding power consumption amount. The method further provides for connecting the one or more power consuming functions with the home energy management system. A signal can be sent with an associated utility through the HEM wherein the HEM includes a controller in signal communication with the associated utility. The controller receives and processes a signal from the associated utility indicative of current costs and energy. The appliance is operated using one or more power consuming functions. The controller converts the current cost to supply energy into a power consumption cost of the one or more power consuming functions wherein the power consumption cost is communicated to the home energy management system which translates a pre-loaded table of power consumption values associated with each of the one or more power consuming functions.

The present disclosure further provides a method of controlling power consumption costs of an appliance comprising connecting one or more power consuming functions with the home energy management system. A signal can be sent from an associated utility to the HEM wherein the HEM includes a controller in signal communication with the associated utility. The controller receives and processes a signal from the associated utility indicative of the current cost of supplying energy. The appliance is then operated in the one or more power consuming functions. The controller converts the current cost of supplying energy into a power consumption cost of the one or more power consuming functions wherein the power consumption cost is communicated to the home energy management system. The power consumption cost of each of the one or more power consuming functions can be multiplied by a respective cycle time in order to calculate the energy cost of each of the one or more power consuming functions.

An energy savings mode of an appliance can thereby be controlled or measured based on consumer selections and utility energy costs. How much energy the appliance consumes is based on selected features and real time cost of energy being supplied to the appliance.

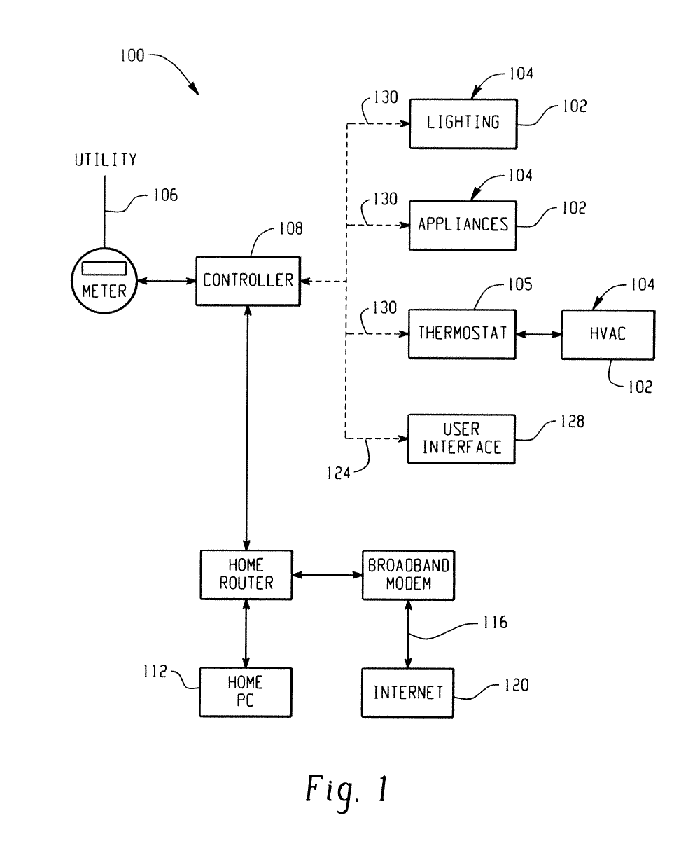

An exemplary embodiment of a home energy management system 100 having one or managed appliances 102 is schematically illustrated in FIG. 1. The appliances 102 each comprise at least one power consuming feature/function 104. The HVAC appliance 102 can include an internal or external thermostat 105. The home energy management system (HEM) 100 is operatively associated with the power consuming features/functions 104. The HEM 100 can include a controller or micro computer which is programmed to selectively control the energization of the power consuming features/functions 104. The HEM 100 is configured to receive and process a signal 106 from an associated utility, whereby the HEM 100, through the controller 108, is in signal communication with the associated utility. The controller 108 is configured to receive and process the signal 106 from the associated utility.

Appliances without a full interactive user interface, i.e. display, can be troublesome to enable the ability to actively monitor the power consumption of user selected appliance features. This disclosure allows the user to use, for example, a home computer 112 to track energy consumption of all appliances so the user can make informed choices regarding the functional features of the appliances. The look-up values can be downloaded 116 from the internet 120, and/or can be communicated 124 to the HEM 100 via a user interface 128 at the appliance. It is to be appreciated that information is being received, manipulated, and communicated by the computer 112 to and from the controller 108 and the interne 120.

Appliances can be delayed in their operation, rescheduled for a later start time, and/or altered in their functioning/features in order to reduce energy demands. The effects of these changes to operation will impact energy consumption. This impact can be displayed to the consumer and monitored/recorded by the HEM. Some appliances lend themselves to an altered operation due to their functionality. For example, dishwashers, clothes washers, and clothes dryers all have the capacity to run as needed because demand on these appliances is either not constant and/or the functions of these appliances are such that immediate response is not necessary. As one illustrative example, a dishwasher that has been loaded during the daytime, i.e., on-peak demand period hours, can be programmed to start its operations for a later, albeit off-peak demand hours. It is to be appreciated that on-peak and off-peak demand hours can correspond to high utility costs and relatively low utility costs ($/kilowatt), respectively. The change to off-peak demand hours, and the associated energy savings, can be displayed to the consumer.

A control method in accordance with the present disclosure comprises communicating with an associated utility and receiving and processing the signal indicative of at least a current utility cost, determining a power consumption cost of a first series of selected features, displaying the power consumption cost of the first series of selected features, changing the first series of selected features to a second series of selected features, and, determining a power consumption cost of the second series of selected features and comparing to the first cost of selected features. The operation of the appliances 102, i.e. selected series of features, may vary as a function of a characteristic of the supplied energy, e.g., availability and/or price.

Variances in power consumption due to changes in line voltage can be accounted for by detecting the line voltage and adjusting the calculated power consumption based on the following equation:

Actual power=120Vpower*(actual voltage/120)

This adjustment can be performed before or after the power consumption value is reported to the HEM. That is, each appliance can be configured to detect line voltage and apply the correction to the stored value, or the HEM can apply the correction to the reported power consumption value after it is received. In the former case, each appliance or device would need access to the line voltage value to perform the correction. In the latter case, the HEM could sense the line voltage of the power coming into the home, and use that value to correct reported power consumption values. If the correction is applied by the HEM, only a single line voltage sensor would be needed and, as such, this could be more economical to implement than providing line voltage sensors on each device.

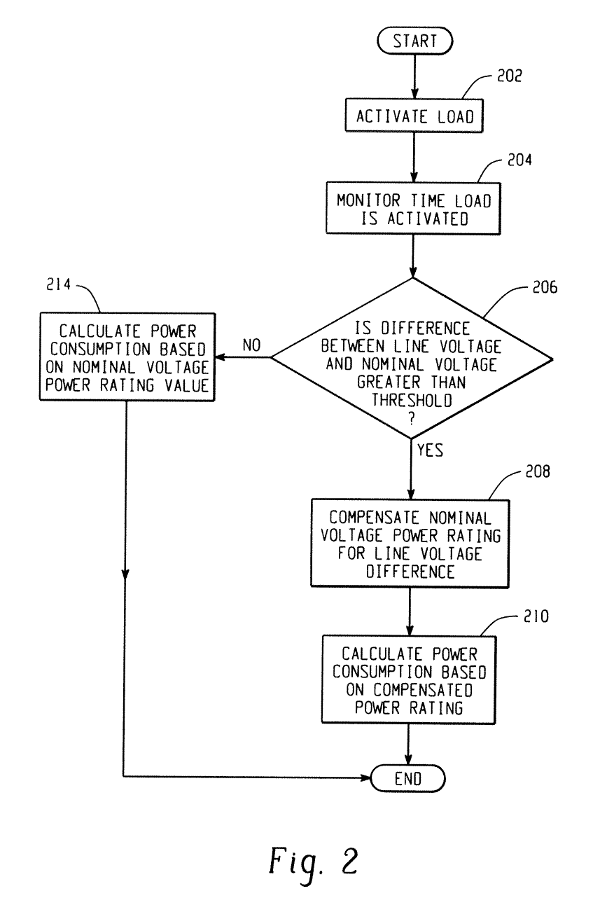

Turning to FIG. 2, an exemplary method of adjusting power values based on line voltage is illustrated in a flowchart 200. The method begins in process step 202 wherein a power consuming function (load) is activated by the controller 108. The controller 108 monitors the amount of time the function is activated in process step 204. This monitoring can simply be an assumption that the function is activated when commanded by the controller, and deactivated when commanded by the controller. Thus, no special sensor or detector need be provided for the monitoring step, but rather can be performed by the controller itself, for example.

In process step 206, the line voltage is compared to the nominal voltage to determine if correction of the power rating value is needed. For example, if the nominal voltage is 120V and the line power is measured to be 110V, then it may be desirable to adjust the power rating value to account for the lower line voltage. A threshold can be set such that if the difference between the line voltage and nominal voltage is less than a certain amount, no correction is applied. For example, if a line voltage sensor has an accuracy of plus or minus 3V, the threshold may be set at 3V such that no line voltage compensation is performed unless the line voltage differs from the nominal voltage by more than 3V. If the difference exceeds the threshold value, then the method proceeds to process step 208 where the line voltage is used to calculate actual power consumption, via the previously noted equation, for example. This compensated power consumption value is then utilized in process step 210 to calculate power consumption by multiplying the compensated power value by the amount of time the load was activated as determined in process step 204.

If the difference between the line voltage and the nominal voltage of the power rating value is less than the threshold, then the nominal power rating value is utilized to calculate power consumption in process step 214 by multiplying the power rating value by the amount of time the particular load was active.

This process can be carried out in real-time as the load is activated. Thus, upon activation of the load, the process may begin to calculate power consumption. Alternatively, the amount of time each load is activated can be stored and then the power consumption of the appliance can be periodically calculated as desired.

As will now be appreciated, the present disclosure provides a system and method for calculating actual energy consumed by an appliance without the need for additional hardware to be installed at the appliance. The disclosure also sets forth a method of compensating for variances in line voltage to achieve a more accurate calculation of energy consumption by a device.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. An appliance with an energy consumption reporting function comprising:
one or more power consuming functions, each of the one or more power consuming functions having one or more operating states associated with respective power consumption value;
a controller operable to activate the one or more power consuming functions, the controller configured to determine an energy consumption amount for the appliance by accumulating the power consumption amounts for each power consuming function based on the amount of time each operating state is detected; and
a communication interface for communicating the energy consumption amount.

2. An appliance as set forth in claim 1, further comprising a memory accessible by the controller for storing one or more power consumption value.

3. An appliance as set forth in claim 2, wherein the one or more power consumption values comprise a monetary value per unit of time.

4. The appliance as set forth in claim 3, wherein the power consumption value is multiplied by a respective cycle time to calculate the energy cost of each of the one or more power consuming functions.

5. The appliance as set forth in claim 4, wherein the energy cost of each of the one or more power consuming functions is summed by the controller to provide a total energy cost consumption of the appliance.

6. An appliance as set forth in claim 1, wherein the communication device includes a display associated with the appliance for displaying the amount of energy consumed.

7. An appliance as set forth in claim 6, wherein the appliance further comprises an input for receiving energy cost data to be used by the controller for displaying the amount of energy consumed as a monetary amount.

8. An appliance as set forth in claim 1, wherein the controller is operable to sense a line voltage of power supplied to the appliance, and further configured to adjust the power consumption values based on the sensed line voltage to thereby account for variances in line voltage.

9. An appliance as set forth in claim 8, wherein the appliance is configured to report the local line voltage via the communication interface.

10. An appliance as set forth in claim 1, wherein the communication interface is further configured to receive a line voltage from a remote source, and communicate the line voltage to the controller, and wherein the controller is configured to adjust the power consumption values based on the sensed line voltage to thereby account for variances in line voltage.

11. A method of determining the energy consumption of an appliance comprising:
associating one or more operating states of one or more power consuming functions of an appliance with a respective power consumption value;
detecting activation of the one or more operating states; and
calculating energy usage of the appliance by accumulating the power consumption value for each power consuming function based on the amount of time each operating state is detected.

12. A method as set forth in claim 11, wherein the one or more power consumption values comprise a monetary value per unit of time, and whereby the power consumption value is multiplied by a respective cycle time to calculate an energy cost of each of the one or more power consuming functions.

13. A method as set forth in claim 12, wherein the energy cost of each of the one or more power consuming functions is summed by a processor to provide a total energy cost of the appliance.

14. A method as set forth in claim 11, further comprising displaying an amount of energy consumed on a display associated with the appliance.

15. A method as set forth in claim 11, further comprising sensing a line voltage of power supplied to the appliance, and adjusting the power consumption values based on the sensed line voltage to thereby account for variances in line voltage.

16. A method as set forth in claim 15, further comprising reporting the local line voltage via a communication interface to a home energy manager.

17. A method as set forth in claim 11, further comprising receiving the line receive a line voltage from a remote source, and adjusting the power consumption values based on the sensed line voltage to thereby account for variances in line voltage.
